(19) United States
(12) Patent Application Publication
(10) Pub. No.: US 2011/0090687 A1
(43) Pub. Date: Apr. 21, 2011

(54) LED illumination device capability of increasing angle of illumination

(76) Inventors: Hung Jie Lin, Sinjhuang City (TW); Yen Wei Pen, Sinjhuang City (TW)

(21) Appl. No.: 12/703,774

(22) Filed: Feb. 11, 2010

(30) Foreign Application Priority Data
Oct. 16, 2009 (TW) 098135011

(51) Int. Cl. F21V 1/00

(52) U.S. Cl. 362/235; 362/294

(57) ABSTRACT

An LED illumination device capability of increasing angle of illumination comprises a heat sink base, an LED illumination module and a transparent, The heat sink base has a first surface, a second surface opposite to first surface and a first fixed portion formed at both sides of the heat sink base, wherein the first surface is formed with two inclined faces contrary to each other, the second surface is formed with a plurality of heat sink sheets. The LED illumination module is mounted on the two inclined faces of the heat sink base individually. The transparent board is formed with two second fixed portion located at the both sides of the transparent, so that the transparent board may be fixed at the first surface of the heat sink base.

### FIELD OF THE INVENTION

The present invention relates to an LED illumination device capability of increasing angle of illumination, and in particular to an LED illumination device whose brightness is improved.

### DESCRIPTION OF THE RELATED ART

Since light emitting diodes (LEDs) feature the high brightness, power saving and long life expectancy advantages, they have been used extensively for the illumination of lamps. Several LED lamps are usually connected to form an LED lamp set, and the position of each lamp can be adjusted to achieve an illumination effect to meet the requirements for a large projecting area and a high brightness, These LED lamp sets are used as illuminating devices indoors and outdoors. However, it is necessary to plan the LED lamps and the layout of different projecting areas, so as to differentiate the projecting area for each LED lamp with a different distance from the LED lamp and the projecting area, and prevent an uneven brightness of the light projected from the LED lamps onto the projecting areas. Therefore, it is an important subject for manufacturers in the related field to design an LED lamp with good directionality and even brightness.

Widely used in recent years is a Light Emitting Diode (LED) illumination lamp that has a benefit of providing illumination of different colors, although higher in price than the typical lamps referred to above. However, the LED illumination lamp poses a drawback in that it tends to be heated up and shows decreased efficiency when used for more than a predetermined time period. Use of the LED lamp for a prolonged period of time may result in excessive heat generation, thus shortening the life span of the lamp.

Please referring to FIG. 1, an exploded view of the traditional daylight lamp includes lamp tube 71 and lamp base 72. The lamp tube 71 has a body 711 and a metal end 712, which has an electrode connection 713. The lamp base 72 has a lamp body 721, electrode base 722 and a starter 723. The electrode base 722 is arranged at the two side of the lamp body 721, and formed with electrode hole 724.

Please referring to FIG. 2, a traditional LED lamp tube includes a core tube 831, a lamp shade 832, a print circuit board 833 and LED 834. Above-mention LED lamp has a single illumination face only, so as to it can not provide double faces illumination.

### SUMMARY OF THE INVENTION

An object of the present invention is to provide an LED illumination device capable of increasing angle of illumination.

To achieve the above-mentioned object, the present invention a heal sink base, an LED illumination module and a transparent. The heat sink base has a first surface, a second surface opposite to first surface and a first fixed portion formed at both sides of the heat sink base, wherein the first surface is formed with two inclined faces contrary to each other, the second surface is formed with a plurality of heat sink sheets. The LED illumination module is mounted on the two inclined faces of the heat sink base individually. The transparent board is formed with two second fixed portion located at the both sides of the transparent, so that the transparent board may be fixed at the first surface of the heat sink base.

### BRIEF DESCRIPTION OF THE DRAWINGS

FIG. 1 is an exploded view of a conventional day-light

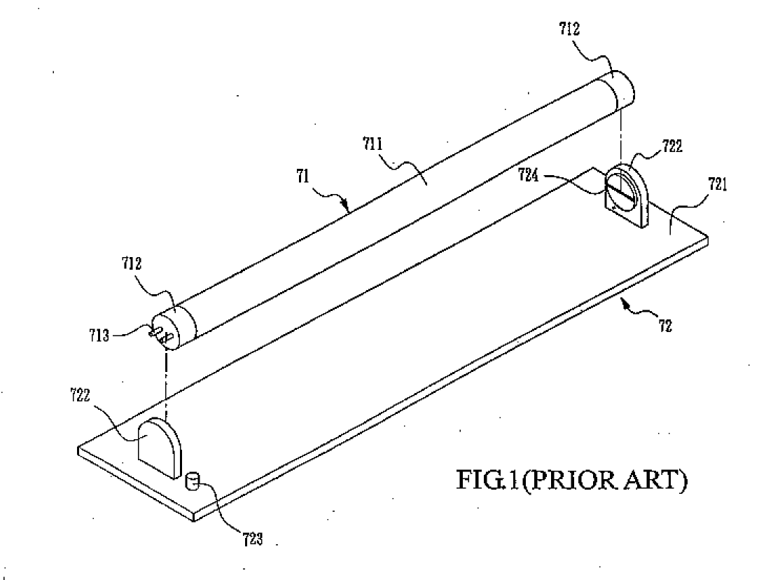

FIG. 2 is an assembling drawing of conventional LED illumination device.

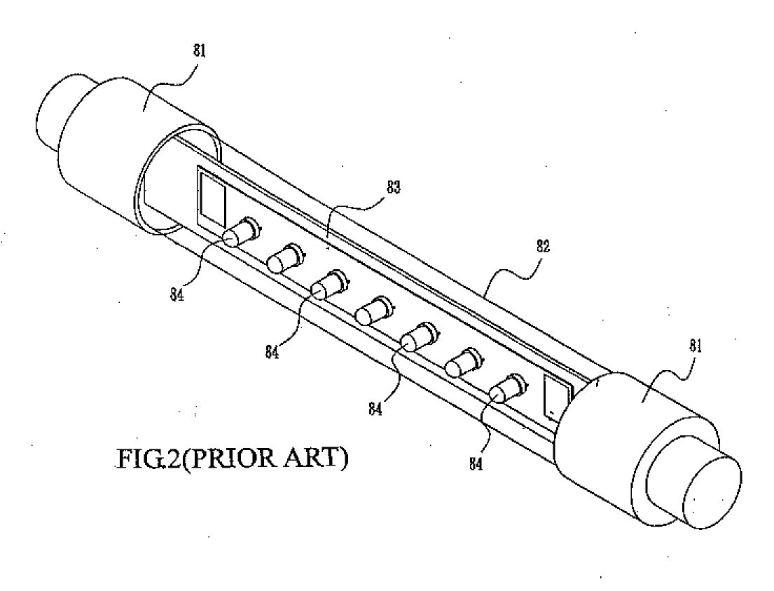

FIG. 3 is an exploded view of present invention.

FIG. 4 is an assembling drawing of FIG. 3.

FIG. 5 is a cross-sectional view of FIG. 4.

### DETAILED DESCRIPTION OF THE INVENTION

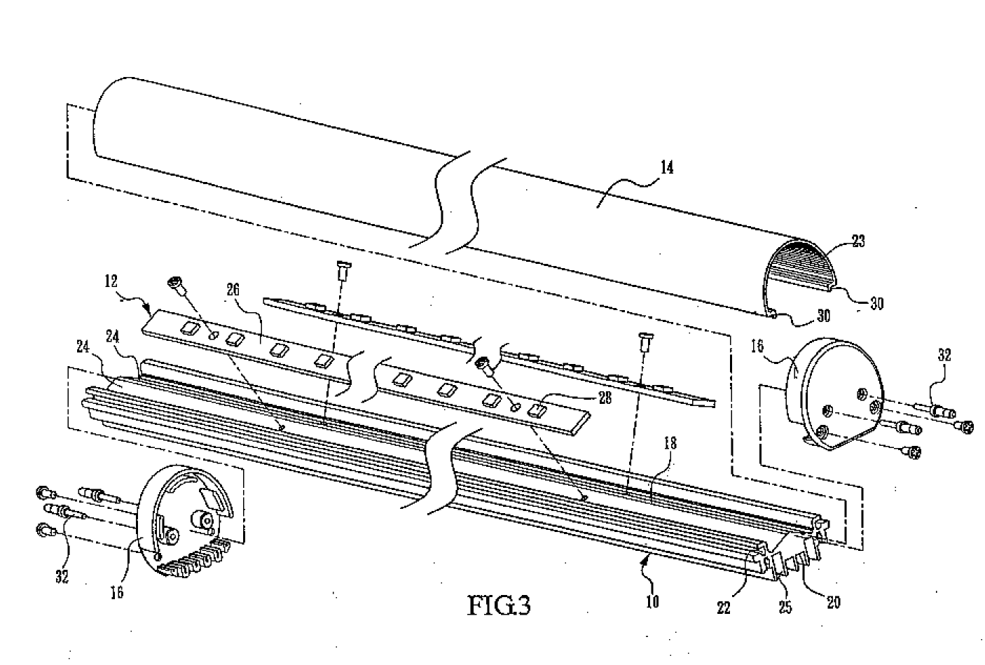

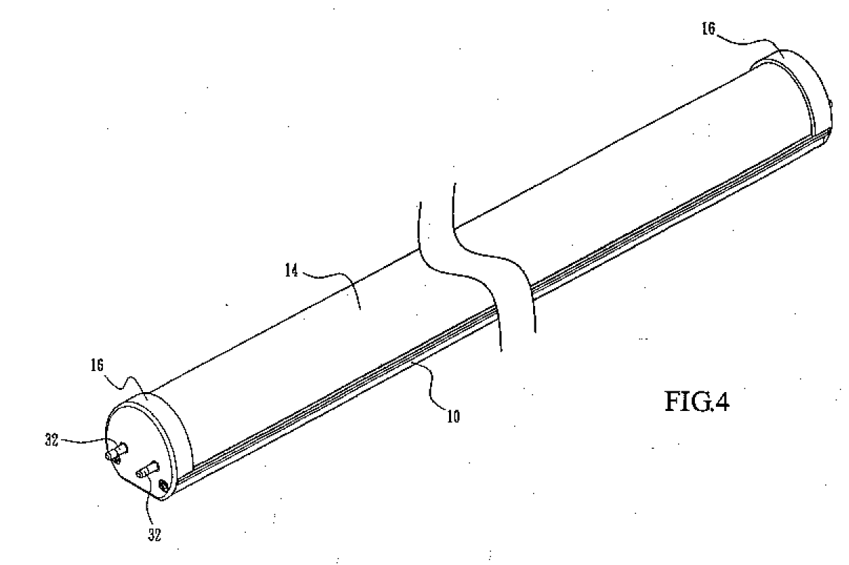

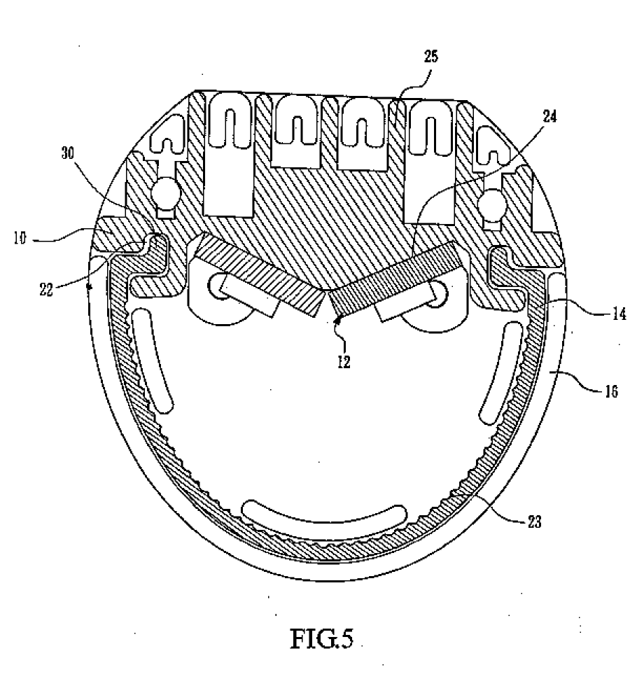

Referring to FIG. 3-FIG. 5, an LED illumination device capability of increasing angle of illumination of the present invention includes a heat sink base 10, two LED illumination modules 14, a transparent board 14 and two side covers 16.

The heat sink base 10 has an first surface 18, a second surface 20 opposite to the first surface 18 and a first fixed portion 22 formed at both sides of the heat sink base 10, wherein the first surface 18 is formed with two inclined faces 24 contrary to each other, the second surface 20 is formed with a plurality of heat sink sheets 25.

The LED illumination modules 12 are mounted on the two inclined faces 24 of the heat sink base 10 individually, each LED illumination module includes a printed circuit board 26 and a plurality of LEDS arranged on the printed circuit board 26.

The transparent board 14 has a convex-concave surface 23 and is formed with two second fixed portion 30, which are located at the both sides of the transparent 14, wherein the second fixed portion 30 may be fixed at the first fixed portion 22 of the heat sink base, so that the transparent board 14 may be fixed at the first surface 18 of the heat sink base 10.

The two side covers 16 arc mounted at the both side of heat sink base 10 and transparent board 14 to cover and electrically connect the LED illumination module 12.

While the present has been described by way of an example and in terms of a preferred embodiment, it is to be understood that the invention is not limited to the disclosed embodiment. To the contrary, it is intended to cover various modifications. Therefore, the scope of the appended claims should be accorded the broadest interpretation so as to encompass all such modification.

What is claimed is:

1. An LED illumination device capability of increasing angle of illumination:
A heat sink base having an first surface, a second surface opposite to the first surface and a first fixed portion formed at both sides of the heat sink base, wherein the first surface is formed with two inclined faces contrary to each other, the second surface is formed with a plurality of heat sink sheets;
Two LED illumination module mounted on the two inclined faces of the heat sink base individually; and
A transparent board formed with two second fixed portion, which are located at the both sides of the transparent board, wherein the second fixed portion may be fixed at the first fixed portion of the heat sink base, so that the transparent board may be fixed at the first surface of the heat sink base.

2. The LED illumination device capability of increasing angle of illumination according to claim 1, wherein the transparent board has a convex-concave surface.

3. The LED illumination device capability of increasing angle of illumination according to claim 1, further comprising two side covers, which are mounted at the both side of the heat sink base and the transparent board.
